(19) United States
(12) Patent Application Publication
(10) Pub. No.: US 2011/0254792 A1
(43) Pub. Date: Oct. 20, 2011

(54) USER INTERFACE TO PROVIDE ENHANCED CONTROL OF AN APPLICATION PROGRAM

(75) Inventors: Keith Waters, West Newton, MA (US); Mike Sierra, Concord, MA (US); Jay Tucker, Arlington, MA (US)

(73) Assignee: France Telecom, Paris (FR)

(21) Appl. No.: 13/142,068

(22) PCT Filed: Dec. 18, 2009
(86) PCT No.: PCT/IB2009/056041

§ 371 Date: Jun. 24, 2011

Related U.S. Application Data
(60) Provisional application No. 61/141,656, filed on Dec. 30, 2008.

(51) Int. Cl. G06F 3/041

(52) U.S. Cl. 345/173

(57) ABSTRACT

A method for imparting control to an application program (AP) running on a mobile device, said method comprising the acts of displaying a graphical user interface (GUI) of the AP on a touch panel of the mobile device; capturing a touch input on a portion of the GUI; the method further comprising, when identifying the touch input as a touch input of a predefined first type, the acts of imparting a first AP control associated to the portion of the GUI; monitoring an occurrence of a spatial movement of the mobile device; imparting a second AP control associated to the portion of the GUI in response to the capture of a spatial movement.

### FIELD OF THE PRESENT SYSTEM

The present invention generally relates to mobile devices or handsets, and more specifically to mobile devices handling both touch and motion based inputs.

### BACKGROUND OF THE PRESENT SYSTEM

Mobile handsets have an inherently impoverished graphical user interface (GUI) with respect to the desktop. Small screens and tiny keyboards are typical of mobile handsets that fit in your pocket. Recent so called smart phones have introduced the use of a touch screen in an attempt to simplify the user experience with his mobile handset.

Another form of input commonly seen nowadays for mobile devices is a motion input: an application program running on the mobile device may be controlled through imparting recognizable gestures to the device. A mapping interface or interpreter is used to associate the gestures to command for controlling the application program. Such devices are for instance known from US 2005/212751 or US 2007/174416 from the Applicant.

Some smart phones have also proposed to associate the two types of input, touch and motion, so as to impart a continuous series of controls to an application program and offer an interactive and easy to use interface with a user. For instance, referring to a picture (or photo) gallery application, a user may display a user interface (UI) on his device display showing miniatures from his picture gallery. Through a first touch input, the user may select one of the miniatures to zoom on the corresponding picture. If that picture was shot with a landscape orientation while the zoom is displaying it in a portray orientation, it may be interesting to rotate the mobile device sideway to bring the screen to the landscape orientation. A motion detector in the mobile device registers the rotation and rotates the picture appropriately. In this illustration, a sequence touch input-motion input brings in an enhanced control of the picture gallery application.

Such a sequence nevertheless has limited usage as it is fully dedicated to the picture gallery application. Furthermore, with the increasing capacities of mobile handsets, more and more complex applications are available to users.

Another example of existing sequence is the control of the Safari™ application on the iPhone™. The user is presented with a number of application icons on the iPhone™ user interface, and can touch the Safari™ icon to start this browser application. The depending on the device orientation, the browser can adjust to portray or landscape mode. These two inputs, touch input to launch Safari™ and motion input to go e.g. to landscape mode, are nonetheless not correlated. Indeed the control of the display mode with Safari™, using the motion input, is independent as the user turn the smart phone at any time and the display will change between the landscape and portray mode, whether the application was just started or not.

Today, tremendous constrains are still imposed on application designers to come up with easy to control applications, requiring limited yet intuitive inputs from users.

None of the here above prior techniques provides a system, method, user interface and device to provide a flexible and interactive control of an application program running on a mobile device.

### SUMMARY OF THE PRESENT SYSTEM

It is an object of the present system to overcome disadvantages and/or make improvements in the prior art.

The present system relates to a method for imparting control to an application program (AP) running on a mobile device, said method comprising the acts of:
displaying a graphical user interface (GUI) of the AP on a touch panel of the mobile device;
capturing a touch input on a portion of the GUI;

the method further comprising, when identifying the touch input as a touch input of a first type, the acts of:
imparting a first AP control associated to the portion of the GUI;
monitoring an occurrence of a spatial movement of the mobile device;
imparting a second AP control in response to the capture of a spatial movement.

In the present system, as other types of inputs are discarded, only a specific type of input will cause the AP to be controlled both through this specific type of input, followed by a motion control. Other types of touch inputs, such as for instance a brief touch, (provided the specific type is different from a brief touch), will only cause a conventional control of the AP. Through the association of the touch-motion inputs triggered when the first type of touch input is identified, a specific mode for the AP can be actuated, allowing an enhanced control of the AP. Conventional controls, like through a simple touch, a long touch or a motion input, offer AP controls that are limited in term of interactions with the user. Thanks to the present system, a user can both control a same AP through known conventional approaches as well as the novel touch-motion approach described herein.

The present system also relates to a mobile device for imparting control to an application program (AP) running on said mobile device, said mobile device being arranged to:
display a graphical user interface (GUI) of the AP on a touch panel of the mobile device;
capture a touch input on a portion of the GUI;
   the mobile device being further arranged, when identifying the touch input as a touch input of a predefined first type, to:
impart a first AP control associated to the portion of the GUI;
monitor an occurrence of a spatial movement of the mobile device;
impart a second AP control in response to the capture of a spatial movement.

The present system also relates to an application embodied on a computer readable medium and arranged to imparting control to an application program (AP) running on a mobile device, the application comprising:
instructions to display a graphical user interface (GUI) of the AP on a touch panel of the mobile device;
instructions to capture a touch input on a portion of the GUI;
   the application being further arranged, when identifying that the touch input is a touch input of a predefined first type, to:
instructions to impart a first AP control associated to the portion of the GUI;
instructions to monitor an occurrence of a spatial movement of the mobile device;
instructions to impart a second AP control in response to the capture of a spatial movement.

### BRIEF DESCRIPTION OF THE DRAWINGS

The invention is explained in further detail, and by way of example, with reference to the accompanying drawings wherein:

FIG. 1 shows a mobile device in accordance with an embodiment of the present system;

FIGS. 2A and 2B show exemplary touch-motion events in accordance with an embodiment of the present system;

FIGS. 3A-3F show exemplary illustrations of spatial movements of the mobile device in accordance with an embodiment of the present system;

FIG. 4 shows an exemplary implementation in accordance with an embodiment of the present method;

FIGS. 5A, and 5B show an exemplary implementation in accordance with an embodiment of the present system;

FIG. 6 shows an exemplary implementation in accordance with an embodiment of the present method;

FIG. 7A-7I show exemplary illustrations of a buddy list application program controlled according to an embodiment of the present system; and,

FIG. 8 shows an exemplary implementation in accordance with another embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For purposes of simplifying a description of the present system, the terms “operatively coupled”, “coupled” and formatives thereof as utilized herein refer to a connection between devices and/or portions thereof that enables operation in accordance with the present system. For example, an operative coupling may include one or more of a wired connection and/or a wireless connection between two or more devices that enables a one and/or two-way communication path between the devices and/or portions thereof. For example, an operative coupling may include a wired and/or wireless coupling to enable communication between a content server and one or more mobile devices. A further operative coupling, in accordance with the present system, may include one or more couplings between two or more mobile devices, such as via a network source, such as the content server, in accordance with an embodiment of the present system. An operative coupling may also relate to an interaction between program portions and thereby may not describe a physical connection so much as an interaction based coupling.

The term rendering and formatives thereof as utilized herein refer to providing content, such as digital media or a graphical user interface (GUI), such that it may be perceived by at least one user sense, such as a sense of sight and/or a sense of hearing. For example, the present system may render a user interface on a touch display device so that it may be seen and interacted with by a user. The term rendering may also comprise all the actions required to generate a GUI prior to the display, like e.g. a map image or a GUI comprising a plurality of icons generated on a server side for a browser application on a mobile device.

The system, device(s), method, user interface, etc., described herein address problems in prior art systems. In accordance with an embodiment of the present system, a mobile device provides a GUI for controlling an application program through touch and motion inputs.

A graphical user interface (GUI) may be provided in accordance with an embodiment of the present system by an application running on a processor, such as part of a computer system of a mobile device and/or as provided by a network connected device, such as a web-based server hosting the application. The provided visual environment may be displayed by the processor on a display device of the mobile device, namely a touch sensitive panel (touch panel in short), which a user may use to provide a number of touch inputs of different types.

A GUI is a type of user interface which allows a user to interact with electronic devices such as computers, hand-held devices, household appliances, office equipment and the likes. GUIs are typically used to render visual and textual images which describe various visual metaphors of an operating system, an application, etc., and implemented on a processor/computer including rendering on a display device. Furthermore, GUIs can represent programs, files and operational functions with graphical images, objects, or vector representations. The graphical images can include windows, fields, dialog boxes, menus, icons, buttons, cursors, scroll bars, maps, etc. Such images can be arranged in predefined layouts, or can be created dynamically (by the device itself or by a web-based server) to serve the specific actions being taken by a user. In general, the user can select and/or activate various graphical images in order to initiate functions and tasks, i.e. controls, associated therewith. By way of example, a user can select a button that opens, closes, minimizes, or maximizes a window, or an icon that launches a particular program. By way of another example, the GUI may present a typical user interface including a windowing environment and as such, may include menu items, pull-down menu items, pop-up windows, etc., that are typical of those provided in a windowing environment, such as may be represented within a Windows™ Operating System GUI as provided by Microsoft Corporation and/or an OS X™ Operating System GUI, such as provided on an iPhone™, MacBook™, iMac™, etc., as provided by Apple, Inc., and/or another operating system.

In the description here after, an application program (AP)—or software—may be seen as any tool that functions and is operated by means of a computer, with the purpose of performing one or more functions or tasks for a user or another application program. To interact with and control an AP, a GUI of the AP may be displayed on the mobile device display.

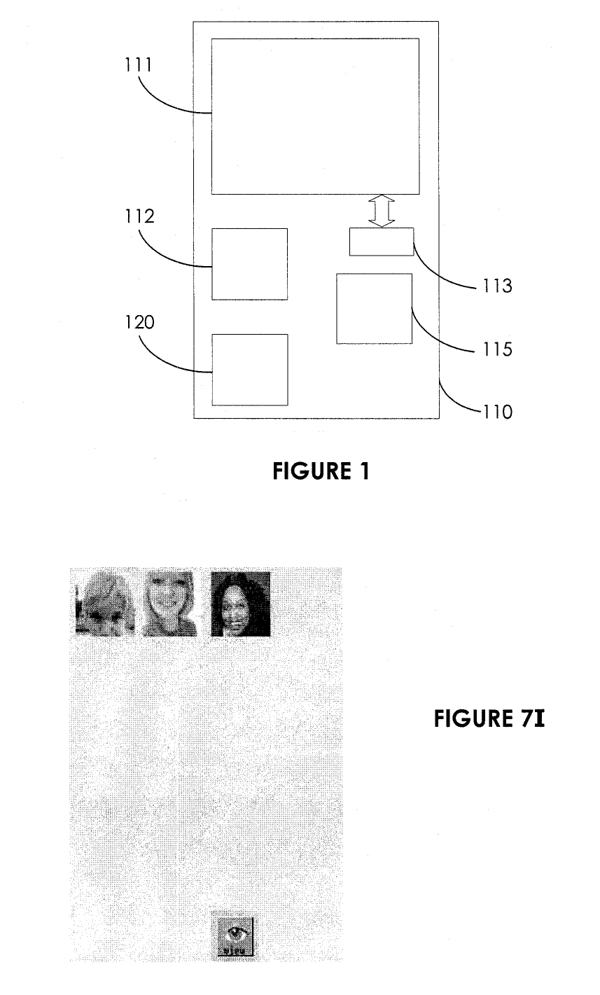

FIG. 1 is an illustration of an exemplary mobile device 110 used in the present system. The mobile device 110 comprises a display device 111, a processor 112, a controller 113 of the display device, a motion detector 120 and an input device 115.

In the present system, the user interaction with and manipulation of the application program rendered on a GUI is achieved using:
the display device 111, or screen, which is presently a touch panel operationally coupled to the processor 112 controlling the displayed interface, and
the motion detector 120 operationally coupled to the processor 112 as well.

Processor 112 may control the generation and the rendering of the GUI on the display device 111 (the information required to generate and manipulate the GUI resides entirely on the mobile device 110) or simply the rendering when the GUI is provided by a remote (i.e. network connected) device (the information, including in some instances the GUI itself is retrieved via a network connection).

The touch panel 111 can be seen as an input device allowing interactions with a finger of a user or other devices such as a stylus. Such an input device can, for example, be used to make selections of portions of the GUI of the AP. The input received from a user's touch is sent to the processor 112. The touch panel is configured to detect and report the (location of the) touches to the processor 112 and the processor 112 can interpret the touches in accordance with the application program and the currently displayed GUI. For example, the processor 112 can initiate a task, i.e. a control of the AP, in accordance with a particular touch.

The controller 113, i.e. a dedicated processor, can be used to process touches locally and reduce demand for the main processor 112 of the computer system. The touch panel 111 can be based on sensing technologies including but not limited to capacitive sensing, resistive sensing, surface acoustic wave sensing, pressure sensing, optical sensing, and/or the likes. Here after, for simplification purpose, reference will be made to a finger of the user touching panel 111, other devices such as a stylus may be used in place of the user finger.

### The Touch Interface

In the present system, different types of touch inputs can be monitored through touch panel 111. For instance, the touch panel 111 can be based on single point sensing or multipoint sensing. Single point sensing can be capable of only distinguishing a single touch, while multipoint sensing can be capable of distinguishing multiple touches that occur at the same time.

In the present system, once the type of touch input has been captured and identified, the captured touch input may be referred to as a touch event (or action) that allows imparting a control on the AP. For single point sensing, the duration and/or frequency of the touch inputs may be taken into account to distinguish different types of touch events. One of the touch inputs illustrated herein may be seen as touching and holding a point on the screen with a single finger, or “clutching” the screen. Clutching the screen is distinguishable from conventional touch inputs by the amount of time it takes to press the finger down on the screen and when the finger is lifted from the screen. A clutch event would only be captured if the finger has not been released from the point or portion on the screen before a given time threshold CLUTCH_THRESHOLD.

In practical terms, a clutch event may for instance initiate after approximately CLUTCH_THRESHOLD=0.5 seconds, making it sensibly longer than a conventional “brief touch” on the screen that triggers conventional events in known systems. However, bearing in mind the user experience, CLUTCH_THRESHOLD would not be so lengthy as to force users to wait idly before a control of the AP is imparted. In practical terms, the clutch event would for instance initiate before 1 or 2 seconds.

### Examples of Touch Inputs

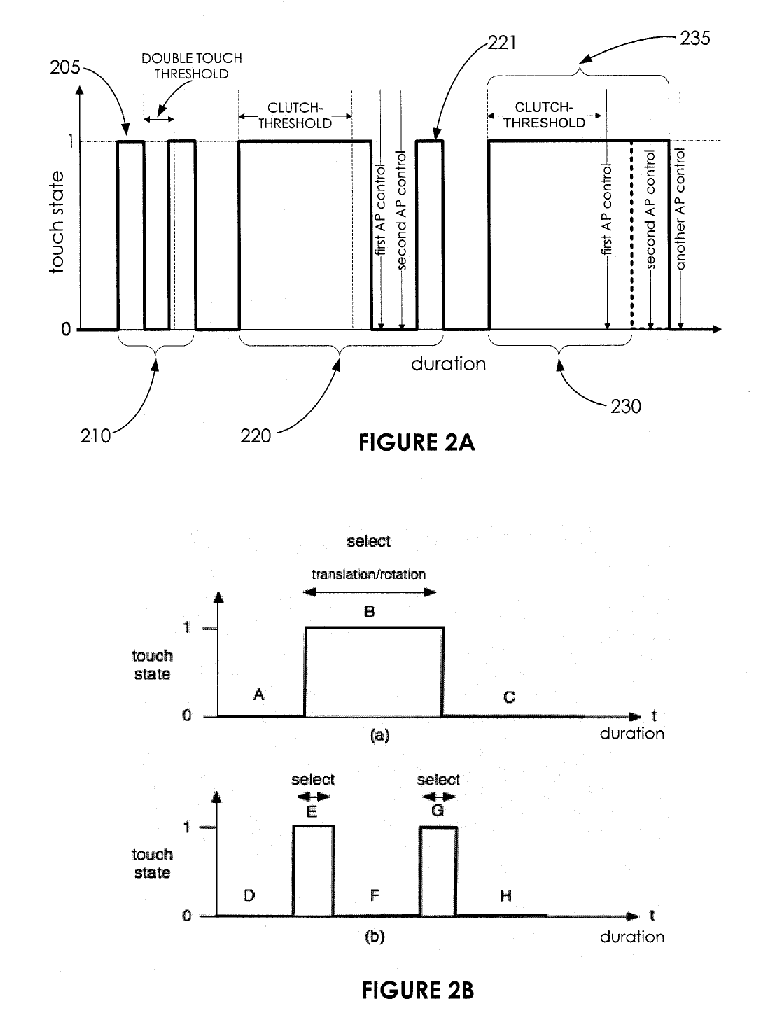

Illustrations of touch events are presented in FIG. 2A. The touch state is either 1 or 0, corresponding to whether or not the screen is pressed. A brief touch 205 is illustrated as a touch event lasting less than a predefined duration CLUTCH_THRESHOLD. A double touch 210 is a touch event comprising two brief touches, separated by a time interval shorter than another threshold DOUBLE_TOUCH_THRESHOLD (as seen on FIG. 2A). Clutch events 220 or 230 are illustrated as touch event lasting longer than CLUTCH_THRESHOLD. As illustrated here after, clutch events may last longer than CLUTCH_THRESHOLD, and their duration and termination can trigger different sequences accordingly.

Other types of touch inputs that can be used in the present system may for instance be a touch on two locations, a sliding of the finger on the screen, a double-touch . . . or any other type of touch inputs readily available to the man skilled in the art.

### The Motion Interface

Referring back to FIG. 1, the present system further comprises a motion detector 120 to produce an output indicative, for instance raw data, of the mobile device motion, output that can be processed by processor 112. Motion detector 120 may for instance comprise a multidirectional or 3D accelerometer. Such a motion detector is capable of detecting rotations and translations of the mobile device. The use of a 3D accelerometer allows the disambiguation of the mobile device motions in some instances. Motion detector 120 may also comprise one or more of a camera, rangefinder (ultrasound or laser for instance), compass (magnetic detection) and/or gyroscope.

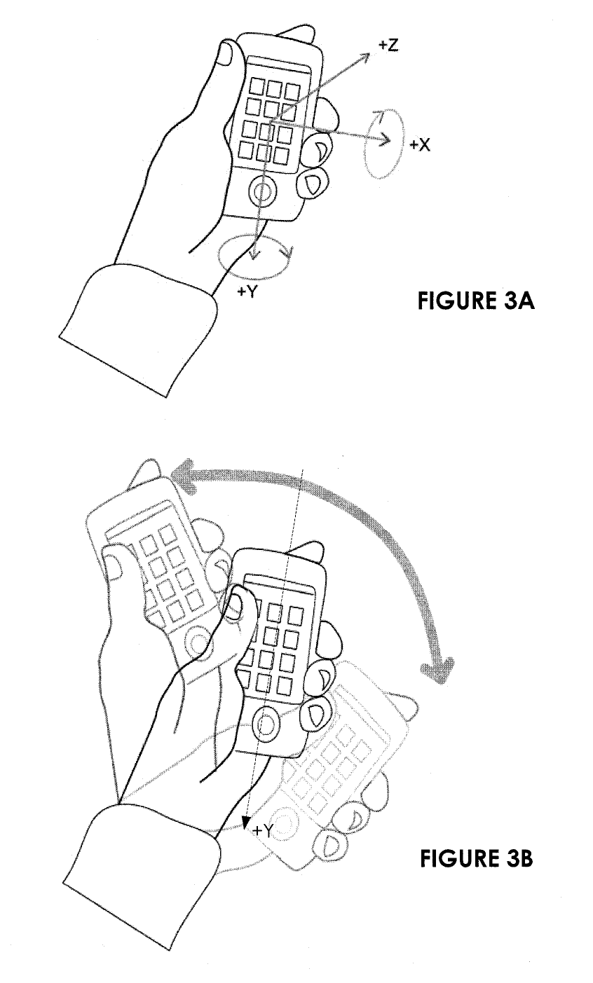

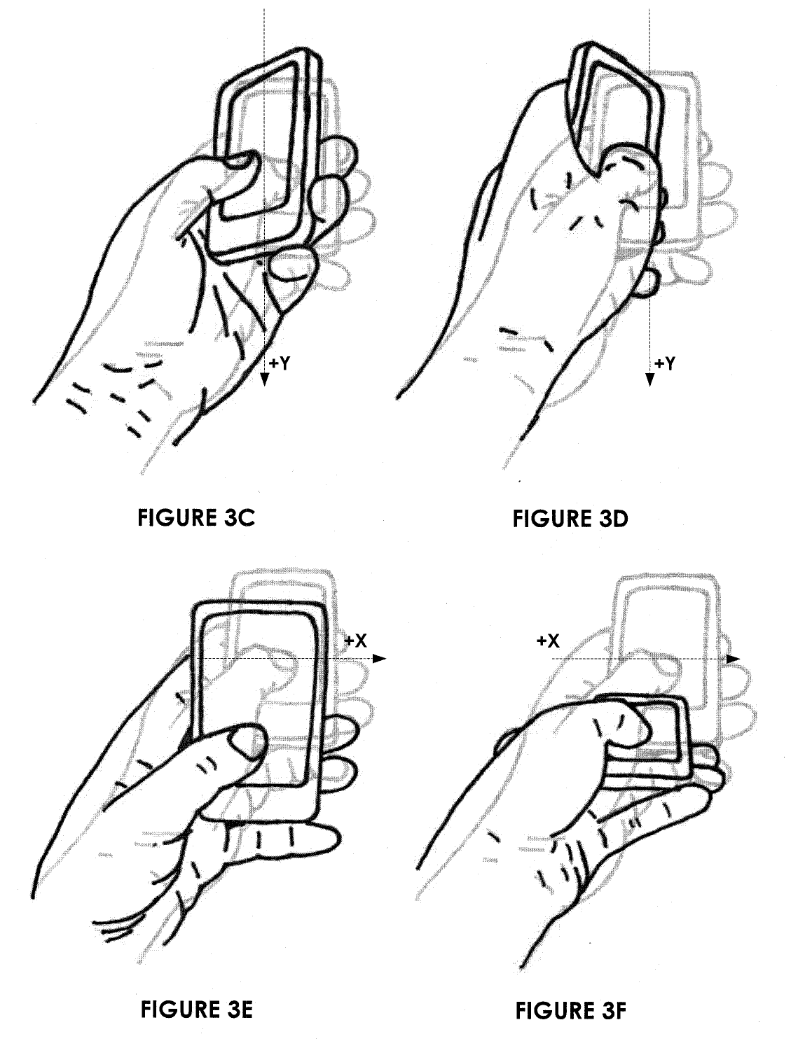

In the present system, the AP may be controlled through the information provided by the full range of spatial motions—or movements—detectible with the motion detector 120 embedded in the mobile device 110. The terminology used here after to describe the mobile device motions is that of a standard 3-dimensional Cartesian coordinate system, one that extends the 2-dimensional coordinate space of the device's touch panel 111. While the touch panel's coordinate system may rely upon screen pixels as the unit of measurement, the motion detector's coordinate system will rely upon units of gravity (Gs) when accelerometers are used. In the here after description, the present system will be illustrated using a 3D accelerometer, but the present teaching may be readily transposed to any motion detector used by the man skilled in the art. As illustrated in FIG. 3A, showing the user's left hand carrying the mobile device 110, the panel or screen's horizontal aspect is its X axis, and its vertical aspect is its Y axis. The top-left corner of the screen may for instance be chosen as its zero point. FIG. 3A shows this coordinate system in relation to the device.

A mobile device at rest on a flat surface, oriented to face the user, would have zero acceleration along its X or Y axis. The device's screen faces its Z axis, with motions in the direction the screen is facing defined as positive. Thus a device at rest on a flat surface would have an acceleration of −1 along its Z axis, representing the Earth's gravitational pull.

Based on the referential illustrated in FIG. 3A, tilting the device onto its right edge, perpendicular to the surface, in the direction of its X axis, rotating it along its Y axis, would result in acceleration of 1x, 0y, 0z. Reversing the tilt to the left would result in an acceleration of −1x, 0y, 0z. Likewise, tilting the device onto its bottom edge, perpendicular to its main surface (the screen), in the direction of its Y axis, rotating it along its X axis, would result in an acceleration of 0x, 1y, 0z. Reversing the tilt onto the top edge would result in an acceleration of 0x, −1y, 0z.

Measurements along any axis could of course fall outside the −1 to 1 range. A device that rests face down on a surface would have an acceleration of 0x, 0y, 1z. If it falls freely towards the Earth oriented in the same manner, its acceleration would be 0x, 0y, 2z. A user snapping the device more forcefully towards the Earth can exceed 2x.

The motions of the mobile device 110 that is detected may be pitch or tilt that is a signed measurement of the angle the mobile device makes with a reference plane. For purposes of illustration, the reference plane is upright (i.e., screen facing the user, although it may be any steady state position). The reference plane may correspond to steady state or neutral position (optionally in some exemplary embodiments, minor movement below threshold detection levels may be ignored as not being legitimate input so as to depart from actual spatial motions). Using Cartesian co-ordinates with the X, Y and Z axes being as shown in FIG. 3A, up and down movements would be detected along the Y axis, right to left movements are detected along the X axis, forward and backward movements are detected along the Z axis. Tilt or pitch for instance is detected along the X and Y axes. FIG. 3B shows an example of a tilt around the Y axis of FIG. 3A.

In the present system, when a touch input of a given type is captured, an occurrence of a spatial movement of the mobile device will be monitored. The spatial movement may be defined by any subsequent changes in acceleration relative to that neutral position over a span of time, or relative to the position the mobile device is in when starting the motion monitoring. Thresholds of movement may be introduced to eliminate minor movements of the mobile device that are not intended to be inputs and thresholds of acceleration may eliminate movements greater than the distance thresholds that occur over such a long period of time that they are judged not to be meaningful inputs. The motion or spatial movement will also be referred to as the motion input, while the captured spatial movement will be referred to the motion event or action.

### Examples of Tilt and Snap Motions

In the present description, the terms “tilt” and “snap” refer to gestures of the human hand holding a mobile device. The term ‘tilt’ is used to describe moderate accelerations of roughly less than 1 G along the X or Y axis while the term ‘snap’ is broader, describing more forceful accelerations along those axes. Additionally, the term ‘snap’ is used to describe all motions that occur along the device's Z axis.

These motions would involve minor wrist actions for motions along the X and Y axis, or slightly more vigorous motions of the forearm for motions along the Z axis, pivoting at the elbow. Tilting or snapping the handheld device would involve pivots at the wrist or elbow, or rotations of the wrist. Pivots would center around the wrist or elbow, not around the device itself.

FIGS. 3C-3F show additional illustrations of tilt motions in accordance with the present system, with:
FIG. 3C showing a positive tilt around the Y axis of FIG. 3A,
FIG. 3D showing a negative tilt around the Y axis of FIG. 3A,
FIG. 3E showing a positive tilt around the X axis of FIG. 3A, and;
FIG. 3F showing a negative tilt around the X axis of FIG. 3A.

While the motions described here correspond to the 3-dimensional Cartesian coordinate system described above and shown in FIG. 3A, combinations of these motions may also be envisaged to impart control over an AP, as well as larger waving motions that entail moving the device around within a physical space. While navigating through a menu (as illustrated here after through exemplary embodiments) may rely upon small physical motions the present system does not prescribe how the scale of the AP control corresponds to the original motion. For instance any degree of acceleration may be required to impart a given AP control so that the AP functions differently depending on the level of acceleration.

### Motions Along the Y Axis

In the case of a rotation along the X axis, a clutch action might be initiated when the device is held upright to face the user at roughly a 45° angle to the ground, as illustrated in FIG. 3B. A subsequent touch-tilt motion running positively along the Y axis would bring the device closer to the user, roughly perpendicular to the ground, pivoting at the wrist with no necessary movement at the elbow. A motion running negatively along the Y axis would move the device farther from the user, oriented roughly face-up and flat to the ground, again pivoting at the wrist.

In both these cases, rotation around the wrist rather than around the device means the device would not occupy its previous position in space. More dramatic movement of the device through space is also likely, and may impart the gesture with additional acceleration. To illustrate, consider a gesture starting from a canonical 45-degree orientation (point A), with the user looking down at the device (0, 0.5, −0.5), then tilting 45 degrees left or right (+−0.5, 0.5, −0.25) (point B). If moving from point A to point B involves a somewhat forceful gesture in which the device is far from the point of rotation (like turning pages in a very large book), some additional positive Z acceleration along the way may be imparted depending on the speed of the gesture, but likely not in a magnitude comparable to the overall shift in Z-orientation. Alternatively, if the above example involves a 45-degree shift up or down along the Y axis, rotating around X at the elbow, the change in orientation means the Z axis shifts roughly as much as the Y axis, despite the possibility of additional Z acceleration imparted by the gesture. For example, from point A (0, 0.5, −0.5) to point B (0, 1, 0) (towards user) or (0, 0, −1) (away from user, face up) involves an overall shift along both Y and Z of 0.5. Rotating the device around one axis always results in shifts to both other axes, regardless of whether the entire device moves through space or whether it simply pivots around the accelerometer embedded within the device.

Motions Along the X Axis

A side-to-side touch-tilt motion in the direction of the X axis, rotating along the Y axis, would require a rotation of the wrist, with no need to move the elbow. The relative freedom of the wrist's rotation may allow the user to pivot the device roughly around its center point, but it may also allow pivots roughly along the edge of the device, much in the manner of how pages pivot along the spine of a book. Again, the device may move through space in its entirely, and not pivot around its center point. Due to the freedom of rotation possible with the human wrist, side-to-side tilt motions along the X axis in the direction of the user (rightwards for left-handed users, leftwards for right-handed users) are more likely to pivot around the device's center point than motions away from the user. Motions away from the user would more resemble how pages turn in a book, involving more significant pushing of the device up with the little finger and ring finger. While the preponderance of acceleration occurs along the X axis, the further the pivot point is away from the device's center point, the more additional acceleration there is along the Z axis.

Motions Along the Z Axis

An up-and-down touch-snapping motion along the device's Z axis would necessarily involve a motion of the forearm, pivoting at the elbow, with no need to move either the upper arm or the wrist. This motion would not involve ‘tilting’ the plane of the front face of the device, but rather snapping the entire plane closer to or farther from the user's face, so that the device as a whole moves through space. The more vigorous forearm motion necessary to affect the device's Z axis would likely make it a less popular alternative than smaller wrist motions that occur along the X or Y axis. Still, the motion along the Z axis may correspond well to the concept of zooming in or out on an image displaying on the screen to affect its level of detail.

### Combination of Touch and Motion Inputs

In the section here after describing different exemplary embodiments of the present system, the various wrist motions described will generally be referred to as ‘tilts’, and the sequence of finger and wrist actions generally as ‘clutch-tilting’ (when the first type of touch input to initiate the sequence is a clutch) or more generally ‘touch-tilting’ (for any type of first touch input triggering the sequence). Rotations along the Y axis are referred to as left or right tilts, while rotations along the X axis are referred to as up/down tilts. Motions along the Z axis are referred to as forward or backward ‘snaps’. Regardless of the specific terminology referring to motions along these axes, the overall motion may combine inputs along any of these axes.

FIG. 2B illustrates two different exemplary implementations of a touch-motion combination. The touch state is either 1 or 0, corresponding to whether or not the touch panel is pressed. The upper sequence (a) indicates a simple interaction. From a state in which the screen is not pressed (A), a clutch-tilt event (detailed above) occurs, initiating a state (B) in which the accelerometer's transition/rotation data affects the interface. Lifting the finger off the screen ends that action and puts the interface into another state (C) in which transition/rotation data does not apply.

The lower sequence (b) represents a more complex interaction. From an initial state (D), a clutch-tilt event initiates a state (E) in which transition/rotation data affects the interface. However, when the finger is lifted from the screen, transition/rotation data may still affect the interface in state F. To get to another state (H) in which accelerometer data no longer affects the interface, the user may need to initiate another touch event (G). This may consist of a conventional touch event, not necessarily a touch-tilt, since it only serves to interrupt the state (F) in which accelerometer data applies. The distinction is that at the end of the initial touch-tilt state (E), accelerometer data may continue to apply to the following state (F). This may for instance be useful when the GUI is modified as further accelerometer data are read, the finger is thus not in the way (fingerless monitoring of the motion), leaving all screen portions visible to the user. In the present system, the touch-tilt event serves to initiate a mode of an AP from/through the imparted AP controls, but the mode does not necessarily end along with the event.

### Exemplary Embodiments of the Present System and Method

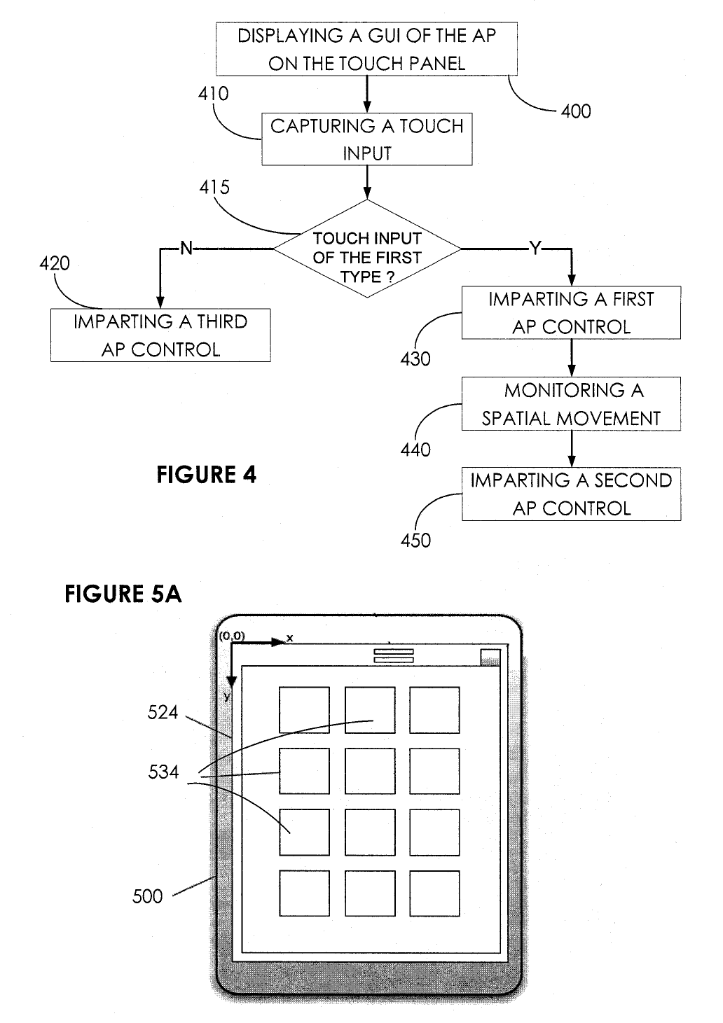

FIG. 4 shows illustrative process flow diagrams in accordance with an embodiment of the present system. An application program is running on the processor 112 of the mobile device 110. Such an AP may for instance be a proprietary operating system, like for instance the Apple™ interface, a web mini application running on a web browser or not, a map application, and the likes. Exemplary APs will be described here after in further details.

In a preliminary act 400, a Graphical User Interface (GUI) of the AP is rendered on the touch panel 111. The GUI may present to the user a plurality of portions for imparting different controls of the AP. Such portions of the GUI may be for instance virtual representations associated to functions of and controls over the AP. For a picture gallery application, this may for instance be the miniatures or icons representing the different pictures of a directory. For a map based application, this may be for example a flag centered on the current location of the device, as captured by a positioning device. More generally this may simply be the welcome page of the AP. Touch panel 111 allows the monitoring of touch inputs on the portions of the application interface GUI.

In a further act 410, a touch input on a portion of the GUI is captured through touch panel 111. In the present system, touch inputs may be of different types. As mentioned before, the touch input could be a brief touch, a clutch, a double touch, a sliding of the finger across the screen . In the present system, a predefined first type of touch input is associated to the monitoring of the mobile device motions. In other words, when a touch input of this predefined first type is identified, the device is put in a state wherein spatial motions are monitored.

In the present system, depending on the type of touch events, different AP controls may be imparted. When a touch event is identified as a touch event of the first type (yes to test 415), a first AP control (act 430) associated to the portion of the GUI is imparted in response to the captured touch event. In an additional embodiment of the present system, when the touch event is of a different type, another AP control associated to the same portion of the GUI is imparted in response to the captured touch event (act 420). Depending on the type of touch events and how the AP is interfaced with the touch panel 111, a number of device behavior may be imparted according to the AP in use. For instance, using the picture gallery application, a brief touch may cause the AP to zoom on the touched miniature to display the corresponding picture, while clutching the same miniature will cause the AP to display a menu for editing, saving or any operations that may be carried on for the corresponding picture. When the touch events can be of a first (e.g. clutch) and second (e.g. brief touch) types, test 415 may be carried out in different ways such as comparing the captured touch input to the first or second types of touch inputs only. In other words, the touch input may be identified as being of one type when not identified as being of the other type.

The enriched user interface of the present system further allows novel and additional interactions when the touch input is of the predefined first type. In an additional act 440 of the present system, as illustrated in FIG. 4 when a touch event of the first type has been identified, the mobile device state changes and spatial movements of the mobile device will be further monitored through motion detector 120. Either before or after imparting the first AP control (act 430), processor 112 will start polling the motion detector raw data. Once a spatial movement has been detected, a second AP control is imparted in response to the captured spatial movement in a further act 450. The raw data from the motion detector 120 may be processed differently depending on the AP. For instance, a motion may be considered as captured once a reading on one axis of the 3D accelerometer exceeds a given threshold. When a user moves his mobile device, motions may comprise several components based on the defined referential of FIG. 3A. When interfacing with the AP requires a specific motion according to one given axis, an axis selection may be used as illustrated in US 2005212751. This may be achieved through filtering the unwanted components of the motions or through amplifying a so called dominant axis based for instance on the magnitude of its acceleration, speed of motion, ratio to other axis readings. Other exemplary implementation may require a library of predefined gesture and an interpreter to map the monitored spatial movement with a predefined gesture and impart a corresponding AP control.

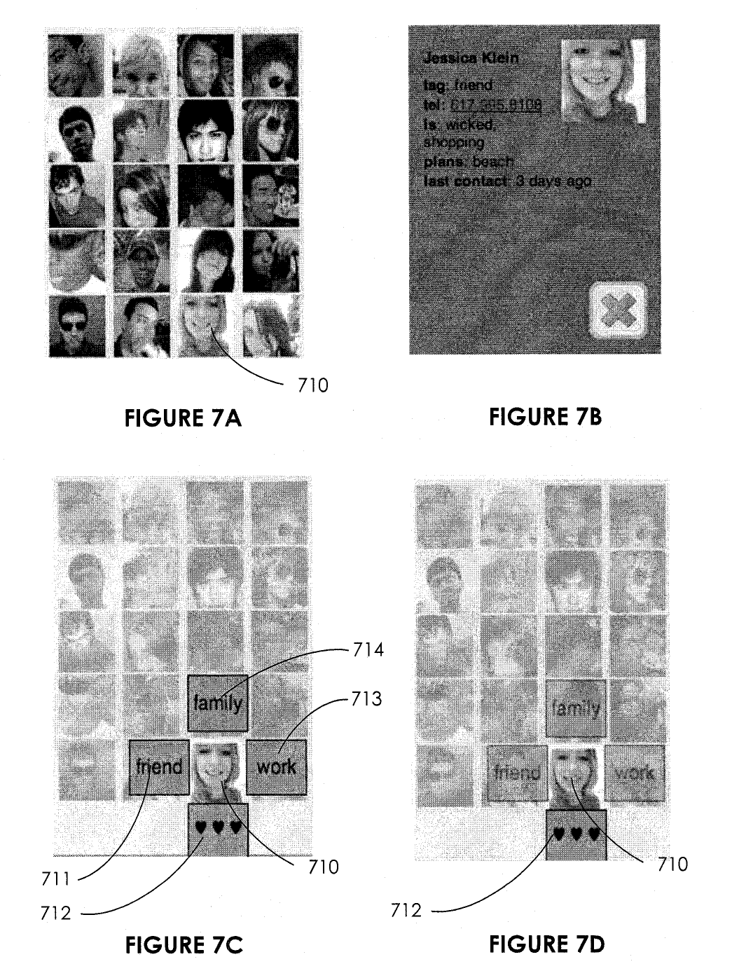

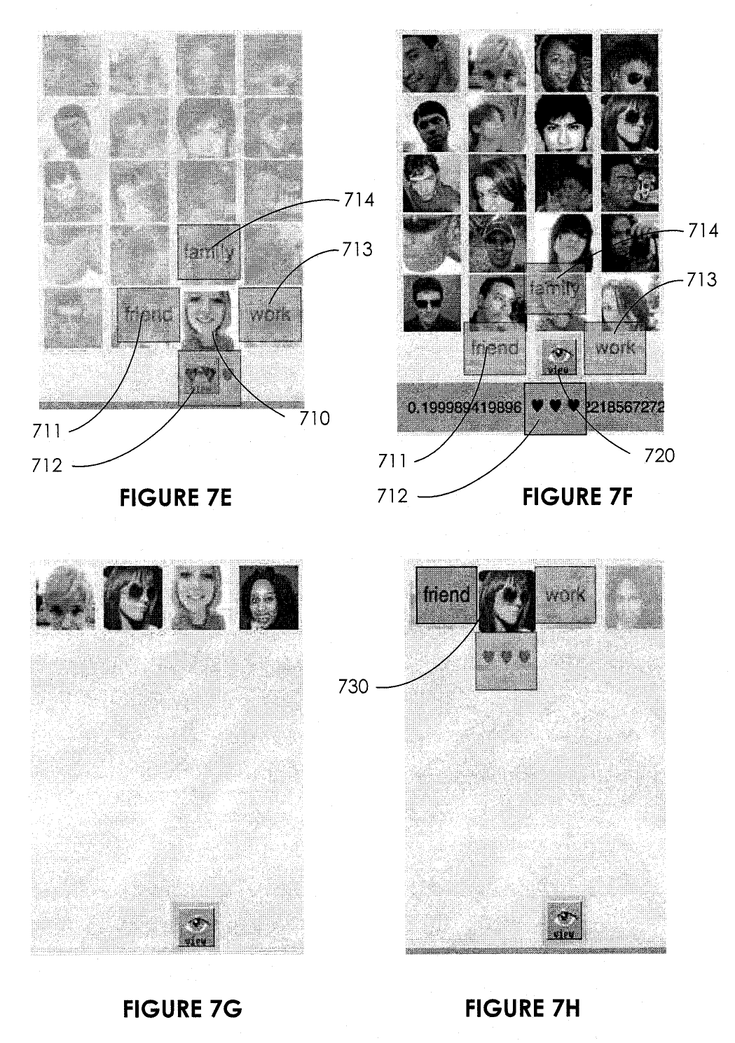

Referring back to FIGS. 2A and 2B, different sequences of touch-motion events may be envisaged depending on how the AP controls are imparted. In a first additional embodiment of the present system, as illustrated by clutch event 220 of FIG. 2A, the monitoring of the spatial movement is carried out once the clutch event is terminated. In this illustration, the first AP control in response to the clutch on the portion of the GUI may be carried out:
either before (i.e. right after the clutch event has be identified). For instance, using the photo gallery application, the first AP control may consist in an animation that dims the other photos while surrounding the clutched photo with a number of interface cues (such as category cues for sorting the photos, as seen on FIGS. 7A and 7C and detailed later on). Once the clutch is identified, the animation will activated even through the finger of the user is still on the clutched photo, or;
after the end of the clutch event (both the imparting of the first AP control and the monitoring of the spatial movement are triggered after. Using the same example of here above, once the user terminates the clutch, the animation will be activated.

In these two examples, once the animation has been activated, the processor can start polling the motion detector for monitoring spatial movements. As seen in FIG. 2A, the monitoring may stop when a further touch input, not necessarily a clutch input, is captured on the touch panel 111. In FIG. 2A, the further touch input is illustrated as a brief touch 221. This corresponds to the modes illustrated in FIG. 2B with reference to the states F, G and H. Other user inputs may be used to stop the monitoring of the spatial movements, such as for instance, but not limited to, pressing a key on a keypad of the mobile device, or imparting a specific spatial movement that can be identified by the mobile device as the termination of the monitoring.

In the second and third additional embodiments of the present system, the touch event lasts longer then CLUTCH_THRESHOLD and the termination of the clutch event imparts a control over the AP.

In a second additional embodiment of the present system, the second AP control is imparted in response to the captured spatial movement once the touch input is terminated, as illustrated with clutch event 230 in FIG. 2A (clutch even ending with the dashed line).

In a third additional embodiment of the present system, the second AP control is imparted if the touch input is not terminated yet, and another AP control is imparted upon release of the finger from the screen. This corresponds to the clutch event 235 of FIG. 2A and the modes illustrated in FIG. 2B with reference to the states B and C. The other AP control may simply consist in interrupting the state (F) wherein the accelerometer data apply. Using the photo application again, once a tilt has been captured, the corresponding interface cue (FIG. 7D) remains on screen while the others are dimmed (second AP control), the release of the finger on the clutched picture 710 will cause the processor to associate the category 712 (romance) to the clutched picture (other AP control).

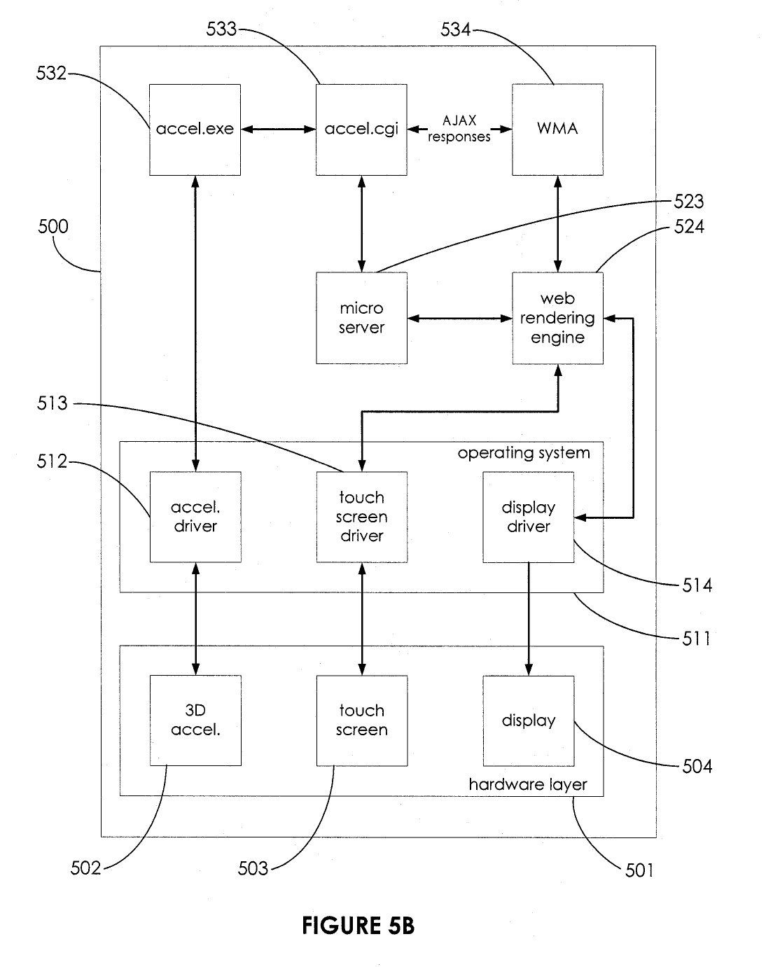

In the here after description, in relation to the exemplary embodiment of FIGS. 5A and 5B of the present system, reference will be made to an AP consisting of a web mini application (WMA) running on a browser hosted by the mobile device 110.

Mobile mini-applications (or web mini application, WMA in short) are web applications that deliver customized visual information to a mobile display. To date mobile mini applications have been developed for a desktop experience, where multiple mini applications can be managed within the context of a browser. Example services are: headline news (developed as RSS feeds), current weather, a dictionary, mapping applications, sticky notes and language translation. “Mobile widgets” is another term associated to WMAs. Essentially they are scaled-down applications providing only key information rather than fully functional services typically presented on the desktop. While they are typically connected to on-line web services, such as e.g. weather services, they can also operate off-line, for example a clock, a game or a local address book. The development of WMAs leverages for instance well defined Web standards of XHTML1.1, CSS2.1, DOM and EcmaScript.

Mobile mini-applications are interestingly suited to small displays where user interactions are hard to perform. Mobile devices such as cell phones or PDAs (personal digital assistants) are good candidate platforms for these mini-applications because the content presentation is condensed to only essential visual components. While WMAs or mobile widgets running on mobile devices are effective source of information, the mechanisms to manage, control and interact with them remains problematic. The here after exemplary embodiments according to the present system will illustrate the management of such mini-applications 534 displayed as virtual representations (e.g. icons) or portion of a GUI within a browser context 524 of a mobile device 500 as illustrated in FIG. 5A.

Thanks to the present system, a user can interact in different ways with a plurality of WMAs 534 displayed for instance as icons comprised in a web page (and displayed on the mobile device touch panel) as seen in FIG. 5A. For instance, the user can zoom on or activate a selected WMA through a brief touch on the icon to display further information, or after clutching the icon, the remaining icons could move around and away from the screen as the device is moved or tilted in different directions. This interaction requires a number of components acting in concert and illustrated in FIG. 5B.

As illustrated in FIG. 5B, the hardware layer 501 of the mobile device 500 may comprise different hardware components on top of the mobile device processor and memories (not shown on FIG. 5B):
a 3D accelerometer 502 as described before, to measure accelerations along the x-, y- and z-axis.
a touch panel 503 for monitoring the touch events. Touch panel 503 is the component of the display 504 capable of sensing user input via pressure on the display (such as a user's finger), and;
a (graphical) display 504 for displaying the GUI of the AP.

An operating system 511, such as Linux, acts as a host for applications that are run on the mobile device 500. As a host, operating system 511 handles the details of the operations of the hardware layer 501 and includes device drivers 512 to 514 which make the hardware components accessible to higher-level software via application programming interfaces (APIs). As seen in FIG. 5B, mobile device 500 makes use of three component drivers 512 to 514, which respectively correspond to hardware components 502 to 504:
the accelerometer driver 512 for high level software to access the 3D accelerometer 502,
the touch screen driver 513 to monitor the touch input on the touch panel 503, and;
the display driver 514 for displaying the AP GUI on the mobile device display 504.

In this present illustration, the mobile device's accelerometer 502 may exposed as a Unix device file (for example /dev/input/accel), which permits accessing it through Unix I/O system calls (open, read, close). The file contains binary data which can be grouped into blocks, with each block containing information on which axis (x, y, or z) the block refers to and the value (in milli-g's) for the current acceleration along that axis. Existing accelerometers allow measurement range for each axis of ±2.3 g, with a sensitivity of 18 mg at a sample rate of 100 Hz, meaning that new values are written to the accelerometer file every 10 ms.

Custom native applications 532, for instance written in C may be used as system tools. Such an application (named for instance accel.exe) uses the Unix system calls mentioned above to read the current values for the acceleration along all three axes and makes them available to the Web Mini Application 534. As an example:

$ ./accel.exe −18 32 −1042

The output indicates acceleration in milli-g's along the x-, y-, and z-axis, respectively, so the above example shows acceleration of −0.018 g along the x-axis, 0.032 g along the y-axis, and −1.042 g along the z-axis, which would be typical values if the device were resting face-up on a level, stationary surface.

The mobile device 500 may also comprise a software stack, such as e.g. a web browser, that makes it possible to display web pages on the device's display 504. Components of such a stack would include a mobile windowing system such as GTK/X11 or Qtopia along with a Web rendering engine 524, such as WebKit, that is capable of rendering or executing standard Web technologies such as HTML (HyperText Markup Language), CSS (Cascading Style Sheets), EcmaScript, DOM (Document Object Model) and SVG (Scalar Vector Graphics) for instance. The web rendering engine 524 generates the GUI for WMA 534 that is displayed on display 504. The web rendering engine is also used to collect the touch events as captured on the touch panel 503.

A small web server 523, called a micro server, written in C language for instance, and executing on the processor of the mobile device 500, is also provided. Such micro servers are known from the Applicant's pending US 2007197230. Micro server 523 may be seen as a common interface for multiple applications and/or functions of mobile device 500. The micro-server (or other comparable software) is capable of, inter alia, receiving and processing information from other functions, both internal and external to the mobile device. This processing includes, for example, formatting the information and delivering information over an HTTP or other link to the web rendering engine 524. Processing by the micro-server also may include receiving data from the engine 524 generated in response to user input, and formatting and forwarding that information to the relevant function or application of the mobile device 500. The micro server may also acts as an application server that dynamically generates data upon request and as a gateway to alternate communications channels (e.g., asynchronous data channels), caching appropriate data locally, and receiving data asynchronously for later use. It may also act like a proxy between the web rendering engine 524 and other entities and networks (including e.g., distant servers, WAP gateways or proxies, etc.), thereby making web browsing more efficient.

In the present exemplary embodiment, the micro server 523 enables Web mini applications 534 to call CGI (Common Gateway Interface) scripts, passing appropriate request parameters if desired. For instance a Unix shell script (named accel.cgi) 533, which can be seen as a thin wrapper around the application accel.exe 532, can be used for WMA 534 to access the accelerometer 502 values. As such this script 533 prepends HTTP headers to the output of the accel.exe application 532, thus making it compatible with Ajax requests from WMA 534 (through engine 524 and micro server 523), as explained in more detail below.

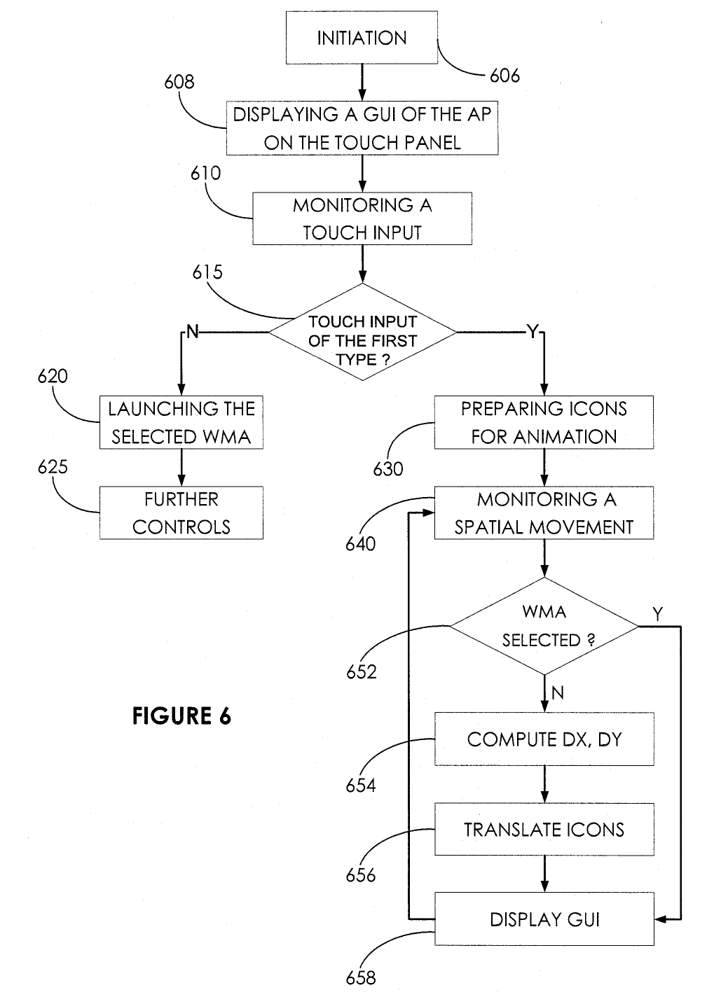

FIG. 6 illustrates an exemplary embodiment of the present method that allows to interact with a Web page that contains a plurality of SVG images (or icons) representing a plurality of WMAs as shown in FIG. 5A. Thanks to the present method, the SVG images will respond to changes in the mobile device's orientation as indicated by the accelerometer values. In the present embodiment, a clutch (longer than 500 ms) is a touch event of the first type while a brief touch (no longer than 500 ms) is a touch event of the second type, with the threshold duration CLUTCH_THRESHOLD set to 500 ms.

In a preliminary act 606, the micro server 523 is started as a background process. The web page comprising the plurality of WMAs from FIG. 5A, here after referred to as the desktop or menu WMA, may itself be seen as a WMA. Generally speaking, Web mini applications can be created using Web markup of HTML, CSS, or EcmaScript for instance.

The menu Web mini application is loaded into the Web rendering engine 524 which generates the menu GUI that is displayed on the mobile device display 504 (act 608) as illustrated in FIG. 5A. This implementation relies on various web technologies: XHTML, providing high-level content markup; CSS, providing presentational markup for content elements; and EcmaScript, providing programmatic functionality. DOM is a web standard describing the model of how these technologies are represented within the browser application that renders the GUI of the menu WMA.

For instance, the XHTML file specifies a number of icons, in this case using the <img> tag, whose src attribute specifies the image file (corresponding to the icon) to display. Items that may be animated all share the same name attribute, in this case trigger:

<img name=“trigger” src=“img/digg.gif”/>

Upon loading the XHTML file and translating its elements into a DOM tree, an onload-triggered EcmaScript function initializes an array of elements suitable for animation (those corresponding to the icons of the WMAs), or for triggering the animation, using EcmaScript's getElementsByName function to gather elements whose name is trigger.

<body onload=“initTriggers(‘trigger’)”>

For each element (i.e. icons) in the array, event listeners are added to the element, using the EcmaScript addEventListener function. These assign a mouseDown handler function to EcmaScript's built-in mousedown event, and assign another mouseUp handler function to its mouseup event. These elements may already specify functions triggered by these events (for instance the execution of the WMA corresponding to the icons shown on the menu GUI). Listeners assign additional functions that execute following any existing functions.

In addition, a boolean isMouseUp variable is initialized at 1, representing the default assumption that a finger is not yet on the screen. Following the display of the menu GUI, the application waits for user input (act 610). As with all event-driven programming languages, EcmaScript features a continuous “idle” loop that detects new events the user specifies. Pressing on the touch screen results in a standard EcmaScript mousedown event, and lifting it from the screen, results in a mouseup. Touching one of the icons causes the mouseDown listener function to execute. That function sets isMouseUp to 0, then dispatches a timed event using the setTimeout function that calls another function handler to execute asynchronously after 500 milliseconds, or half a second:

setTimeout(testMouseUp, 500);

As the testMouseUp function executes ‘asynchronously’, other functions may execute during the half-second interval specified by setTimeout's timing function, most significantly, the mouseUp handler. The main function of the mouseUp handler is to (re)set isMouseUp to 1, a setting used to distinguish between a brief touch and a clutch. The mouseUp handler may also invoke clearinterval to end execution of an already existing accelerometer driven action, but only if lifting the finger is intended to serve as the signal to end that action. Otherwise, for actions that are to persist after lifting the finger (sequence E-F-G of FIG. 2B for instance), the clearinterval can be invoked in the mouseDown handler from which the initial setTimeout is launched, such that if a tilt action is currently executing, a subsequent touch will halt these actions. Alternatively it may be called independently from any other screen elements or operations.

The testMouseUp handler tests the state of isMouseUp. If it is true (answer no to test 615), it means the finger has lifted off the screen during the half-second period, in which case a brief touch event has been captured. Acts on the left hand branch in FIG. 6 may further be carried out as the captured touch event is not a clutch (answer No to test 615). For instance, the WMA corresponding to the selected icon may be launched (act 620). Depending on the mini application selected, further actions may be required from the user (act 625).

If isMouseUp is false, it means the finger is still on the screen, i.e. that a clutch event has been captured (answer Yes to test 615). In the present illustration, as the motion of the mobile device will cause the “unclutched” icons to move around and away from the screen, whether the user keeps his finger or not on the clutched icon does not make a difference. Subsequent examples will illustrate how the type of clutch events, as shown in FIG. 2A-2B, can be used to impart different controls of an AP.

In a further act 630, in response to the identified clutch event, a first AP control is imparted to the menu WMA, namely the menu GUI with the virtual representations is prepared for animation. The position of each icon of the menu GUI is fixed to an absolute coordinate system based on its current X/Y offsets. In the present illustration, this act 630 relies on the fact that, by default, a web rendering engine places elements on a GUI relative to each other, in such as way that its position cannot be directly manipulated. As illustrated with this example, the AP controls may correspond to controls over the AP that are not visible to the user.

In order to capture the mobile device motions (act 640), within the testMouseUp function, an Ajax XMLHTTPRequest object is then created and initialized. This object contacts the micro server 523 and makes a request for accel.cgi 533. Micro server 523 then creates and starts a new process running accel.cgi 533. Subsequently, the accel.cgi script 533 runs, calling the custom native application accel.exe 532. The accel.exe application 532 runs and returns the current accelerometer values for the x-, y-, and z-axis.

The XMLHTTPRequest object's onreadystate callback function is called, indicating that the Ajax request has retrieved new data. The XMLHTTPRequest object's responseText member contains the data returned by the accel.exe application 532. The EcmaScript method retrieves the 3D accelerometer data from the XMLHTTPRequest object's responseText member.

As accelerometer data need to be initialized, once the first accelerometer data are captured, the data are extracted and assigned to the original values for the X- and Y- accelerations, namely origX and origY (in this illustration, Z-axis accelerations may be ignored). Once the accelerometer data are made available; the animation—wherein the clutched icon remains on screen in its initial position while the other icons are moved sideways—can commence. This corresponds to the second AP control associated to the clutched icon and is illustrated as acts 652 to 658 in FIG. 6. Herein the second AP controls are multiple controls as a loop is implemented to move the “unclutched” icons.

The animation is triggered by EcmaScript's setinterval timer function, which sets an animation interval value for instance to 20 ms:

process=setInterval(animate, 20)

Until the clearinterval described above halts this operation, the animate function is called repeatedly every 20 milliseconds, representing the animation's frame rate. (The process variable is the key specifying the action halted by clearinterval.)

In order for the EcmaScript to manipulate the DOM of the webpage and update the menu GUI to reflect the current accelerometer values, the elements of the array suitable for animation will be handled differently whether their correspond to the selected WMA (clutched icon) or not. In other words, the animation function will loop over relevant elements, while ignoring the currently clutched element.

If the element is the clutched icon (yes to act 652), its position will be kept in the updated menu GUI (also called frame here after). For the other elements (No to act 652), their respective displacement Dx, Dy will be computed based on the captured accelerometer data in a further act 654. The animation function will extracts the current accelerometer values, assigning them to currX and currY. A multiplier that assigns accelerometer values to the animation's pixel space may be used. For example, an accelerometer value of 1000 milli-g's (1 g) may correspond to shifting the element for each update by 10 pixels. In this case the accelerometer value would be divided by 100, then rounded to the nearest integer (here after referred to the multiplier function). To calculate Dx and Dy, CurrX and currY may be compared to origX and origY respectively. If the current value for acceleration is different than the original value, the acceleration variation is calculated and the multiplier function will give the signed translation values (Dx, Dy) of the elements. Adding these values from the corresponding X (left) or Y (top) current position of each element will give its current new position (act 656). Each subsequent update of the GUI (act 658) will move the elements around on the screen, based on how much the mobile device is tilted from its position when the animation was initiated. The elements can appear to fall off the edge of the screen if their respective coordinates fall outside the range of the display coordinates.

Thanks to the present method, an enhanced user interaction is achieved as once any icon is clutched, subsequent tilts of the mobile device will cause other icons to animate so that they visibly fall off the display.

In the section here after describing additional exemplary embodiments of the present system, the various wrist motions described will generally be referred to as ‘tilts’, and the sequence of finger and wrist actions generally as ‘touch-tilting’. Rotations along the Y axis are referred to as left or right tilts, while rotations along the X axis are referred to as up/down tilts. Motions along the Z axis are referred to as forward or backward ‘snaps’. Regardless of the specific terminology referring to motions along these axes, the overall motion may combine inputs along any of these axes.

Another exemplary embodiment of the present system is illustrated in FIGS. 7A to 7I. In this illustration, a buddy list WMA is controlled using the present system. The here after example will also use the clutch event as the first type of touch that triggers the motion monitoring, while a brief touch will impart a different type of control.

FIG. 7A represents the initial state of the buddy list application. This present illustration could also apply to a photo gallery application as the icons can be seen as photo miniatures. A plurality of contacts (20 illustrated) is represented through associated buddy pictures (known as “pics”). As can be seen on FIG. 7A, the user of the buddy list may touch Jessica's pic through a brief touch. The touch event causes a standard mouseDown event. The interface may be enhanced through a highlight function that causes the pic to be slightly displaced so as to mimic the pressing down of a button.

A default functionality in this embodiment, corresponding to known buddy list applications for instance, is called. As seen in FIG. 7B, the application control resulting from the brief touch causes a detail of the contact Jessica to be shown on screen in place of the buddy list. Touching the last X cross will cause the application to return to the initial state of FIG. 7A.

Conversely, FIG. 7C shows what happens when the Jessica pic is clutched, i.e. touched for a duration longer then CLUTCH_THRESHOLD. All other pics, except Jessica's pic 710 are dimmed, and four icons (or interface cues) surrounding Jessica's pics appear. This corresponds to the first AP control associated to Jessica's pic, and resulting from the identified clutch event. The four icons illustrate buddy categories and are respectively:
a friend icon 711,
a romance icon 712,
a work icon 713, and;
a family icon 714.

The monitoring of the acceleration is started. A tilt threshold may be associated to all four icons so that once the threshold is passed, the icon in the corresponding direction (romance icon 712) remains while the other are dimmed as seen in FIG. 7D. This corresponds to the second AP control. In this example, once the right buddy category has been selected, the user may release his finger from the screen to associate the selected category to the contact Jessica. This corresponds to the clutch event 235 of FIG. 2, i.e. that further motions can be applied to the mobile device as long as the finger is still touching Jessica's pic. For instance, if the romance icon has been wrongly selected, the user can tilt in the reverse direction, which will cause all the four icons to appear simultaneously. The selection of one category icon through motions and the dimming of the others can be seen as the second AP control (associated to Jessica's pic 710) that is imparted once a motion has been captured. As long as the finger is not released, the user can change the selection of category icons (meaning that the spatial movement is still monitored), and further second AP controls are imparted as long as the clutch event is not terminated. Once the right category is selected, the release of the finger will cause the application to associate the selected category to the contact, i.e. to impart another AP control associated to Jessica's pic.

Alternatively, if the finger is not longer in contact with Jessica's pic 710, the second AP control will remain while the others are dimmed. Further tilts can allow the user to change his mind. Once the right category is selected, a further touch input (whether a clutch or not) on the selected category cue 712 will terminate the monitoring of the spatial movements, associate the corresponding category to the contact, and may cause the application to return to its initial state of FIG. 7A. This correspond to FIG. 2B, with the sequence of states E-F-G, as the fingerless monitoring of the spatial motions allows all screen portions to remain visible to the user.

With one category assigned to the contact, the application will return to its initial state of FIG. 7A. When the tilt imparted by the user on the mobile device is not sufficient to exceed the tilt threshold, the GUI may be updated so as to inform the user that he needs a firmer gesture. This illustration is shown in FIG. 7E, wherein all category icons 711 to 714 are dimmed to show the user that a category has yet to be selected. This may for instance be implemented as part of the repeating setinterval-triggered function, wherein the AP will actually dim all four icons as a default assumption, then determine the preponderant direction of the motion. If the threshold is exceeded, the corresponding icon will be highlighted (second AP control), otherwise nothing will be done.

As seen in FIG. 7F, an additional view button 720, may be provided on the GUI of the buddy list application. When the user clutches view button 720, once the clutch event is identified, the AP control as shown in FIG. 7E in relation to the view button 720 will be the same as the one illustrated in FIG. 7C for Jessica's pic 710. The same 4 category icons 711 to 714 are displayed around the view button 720. As previously, the monitoring of the mobile device motion is started, and once a tilt threshold is exceeded in one direction, a category icon can be selected (romance icon 712 as seen in FIG. 7F). The release of the clutch will cause the application to show the contacts from that romance category as seen in FIG. 7G, contacts that include Jessica as her category has been updated to “romance”.

By further clutching onto Emily's pic 730, the user can further re-categorize one of the buddies from the romance list seen on FIG. 7G. Another clutch-tilt event will cause the application to update the status of the contact Emily to another category, say friend, the GUI will subsequently be updated once the clutch is terminated. In other words, the application will impart another AP control to update the GUI with a list of now 3 contacts in the romance category as seen in FIG. 7I.

Alternatively, the buddy list application could be configured to not only show the selected category icon while dimming the others, in response to the captured tilt, but also to associate the selected category to the clutched contact pic. This more “complex” second AP control could be used for instance whether the contact pic is still clutched or not. If the contact pic is still clutched, the termination of the clutch event may cause another AP control to return e.g. to its initial state (FIG. 7A—clutch event 235 of FIG. 2A). In the configuration wherein the contact pic is no longer clutched (clutch event 220 of FIG. 2A), the category icons will appear once the clutch event is terminated (first AP control). The monitoring of the motion will also start as the clutch event is terminated. Optionally, as the user's finger is no longer in contact with the screen, the category icon selected from the tilt could itself be associated to the present method, i.e. that is could either be:
selectable through a simple touch that may also terminate the monitoring of the spatial movement, or;
a clutch-tilt sequence with additional AP controls in the form of menus or additional interface cues, allowing the use of the present method one more time.

### Examples of Implementation of the Present System

In a first exemplary embodiment of the present system, the mobile device display may represent a menu GUI showing an array of icons representing a group of web mini applications. A brief touching on an icon will launch the application; while clutch-tilting an icon presents a separate interface such as a configuration menu for the WMA, allowing the user to configure the application.

In a second exemplary embodiment of the present system, the display may show a GUI comprising an array of icons representing pictures (pics) of a user's contacts within the context of a social networking application. Touching and holding an icon would cause a first AP control that presents additional icons or interface cues (as seen in FIG. 7 for instance) informing the user of different options depending on the direction of the tilt. Subsequently tilting the device in one direction would add an interface element displaying the friend's location. Tilting the device in other directions would display the friend's current status or mood, the friend's own number of friends, or the option to initiate a telephone call. Subsequent tilts would return to the original display state, or else would navigate to the other top-level options described above.

In a third exemplary embodiment of the present system, the previous example could be modified slightly to allow deeper navigation, in much the same manner as navigation through a set of hierarchical sub-menus. While an option is selected, additional interface cues would allow further navigation. For instance, it would navigate to shared friends the initial friend has in common with the user. This embodiment demonstrates how a sequence of more than one tilting inputs triggered by a single touching input may navigate among a complex set of options.

In a fourth exemplary embodiment of the present system, the mobile device GUI displays an array of icons representing pictures of as many of a user's friends as will fit on the screen. Touching a specific control may display a series of sorting options. Touch-tilting to select one of those options would rearrange the icons depending on a friend's attributes, such as geographic distance, most recent contact, or overall frequency of contact.

In a fifth exemplary embodiment of the present system, the mobile device interface displays an array of icons representing pictures of as many of a user's contacts as will fit on the screen. Touching a specific control may display a series of filtering options. Touch-tilting to select one of those options would rearrange the icons, displaying only those that match certain criteria, such as whether they're categorized as ‘family’ or ‘colleague.’ Subsequent tilts as part of the same touch action, or additional touch-tilts, could apply additional filters.

In a sixth exemplary embodiment of the present system, the mobile device GUI displays the surface of a billiards table. Touch-tilting the ball launches it in the corresponding direction, with the degree of the tilt motion's acceleration affecting the speed of the ball. This embodiment demonstrates how the tilt action is not limited to a set of discrete choices along any one axis, but could specify a more precise vector.

In a seventh exemplary embodiment of the present system, the mobile device GUI displays a series of photos within a gallery. Touch-tilting left or right navigates back and forth within the gallery, with subsequent tilts allowing further navigation. Touch-tilting forward or backward (i.e. in the direction of or away from the user) within the photo would zoom in or out from a selected point.

In a eighth exemplary embodiment of the present system, the mobile device GUI displays a series of photos within a gallery. Touching a photo will zoom on the picture, while clutch-snapping one photo (using acceleration in the Z direction perpendicular to the mobile device display) would zoom in or out on the clutched photo. The zoom control can be active as long as the finger is maintained on the photo (clutch event 235 of FIG. 2).

In a ninth exemplary embodiment of the present system, the mobile device GUI displays information on a track from an audio playlist. Touch-tilting left or right navigates back and forth within the playlist. Touch-tilting up or down navigates to other tracks on the same album, or to tracks by the same artist.

In a tenth exemplary embodiment of the present system, the mobile device GUI displays data along an axis, such as a schedule of events distributed along a horizontal timeline. Touch-tilting left or right would scroll back or forth in time, accelerating with the degree of tilt. Touch-tilting forward or backward might affect the scale of time being displayed: zooming in to view hours or minutes, or zooming out to view weeks or months. Touch-snapping forward or backward along the Z axis might alter the view scale to display an optimum number of data points.

In an eleventh exemplary embodiment of the present system, the embodiment described immediately above could be modified to perform different controls depending on the degree of acceleration. Touches accompanied by gentle tilts would perform the continuous scrolling or zooming controls described above. Touching with more forceful snapping motions in the same directions as the tilts would navigate among currently displaying items.

In an twelfth exemplary embodiment of the present system, the mobile device GUI displays a north-oriented map. Touch-tilting up, down, right or left navigates north, south, east or west, respectively. Combinations of touch-tilts along the X or Y axis allow navigation along specific vectors. Touch-snapping forward or backward would zoom the altitude or the scale of the map in or out.

In a thirteenth exemplary embodiment of the present system, the embodiment described immediately above could be modified to perform different actions depending on the degree of acceleration. Touches accompanied by gentle tilts would perform continuous scrolling or zooming actions within geographic space. Touching with more forceful tilts would navigate among currently displaying location points. The combination of X and Y axes would form a vector, allowing more precise navigation among available points than simple left, right, up, and down motions.

In a fourteenth exemplary embodiment of the present system, the mobile device GUI presents an audio-enabled application. Touching an icon displays a pair of controls: a vertical and horizontal slider bar, corresponding to volume and bass/treble. Touch-tilting along one slider bar affects the corresponding control, with each successive tilt motion.

In a fifteenth exemplary embodiment of the present system, the mobile device GUI displays a news portal website via a web browser that has been extended to recognize touch-tilt events. The website's layout has many columns, and its content is not ordinarily accessible on narrow mobile screens. Touch-tilting back or forth may zoom in to display specific columns, or zoom out to view the larger page.

In a sixteenth exemplary embodiment of the present system, the mobile device GUI displays a sound button on a media player application. Clutching the sound button allows adjustments of the volume of a currently playing media file. For instance a slider bar may be displayed left to right on the GUI and as the user tilts the mobile device to the right, the volume will increase. The display of the slider bar is of course optional as the user may simply know that the touch tilting will give him access to the volume control.

Overall, touching the screen of a mobile device and tilting it are two different actions. This invention combines these two actions in unique ways to provide a novel means of navigation and control of a mobile user interface. Touch and tilt can be invoked with a single finger and hand motion to form a specific task.

In the present system, the finger when used to clutch the screen may for instance be the thumb of the hand holding the device, and all of the motions described herein would be possible to accomplish using one hand, assuming the mobile device fits comfortably within the palm of the hand.

This combination of actions is distinct from either action occurring in isolation. The combination of actions improves the functionality of AP GUI by allowing tilt actions to be associated with distinct functional regions of the screen specified by the touch input. A tilt action without an accompanying touch action would only allow the mobile interface to support a single tilt-activated item. The touch-tilt interface offers a novel way to make a much wider range of interface options available than would ordinarily be available on the screen of a mobile device.

Furthermore, the present exemplary embodiments have been illustrated using a clutch on a portion of the GUI as the type of touch input that triggers the monitoring of mobile device motions, while a brief touch on the same portion, i.e. a second type of touch input different from the first type, does not lead to a control of the AP through motions. The man skilled in the art can implement the present teachings to a system wherein the first and second types of touch inputs are one of a sliding of a finger or stylus, a double touch, a clutch or a brief touch. Other types of touch inputs could be envisaged to increase the user interaction with the AP.

For the duration of a touch-tilt event, there is no prescription on how the application interprets available transition/rotation data. To illustrate this point, one can consider an application program in which touch-tilting to the left or right navigates from one image to another within a photo album. When the touch-tilt event is initiated, the application might store the initial accelerometer coordinates as a neutral state from where the action starts. If the device subsequently accelerates in one direction, exceeding a given threshold, the application might interpret that change as a signal to navigate to the next image. However, subsequent acceleration back towards the initial starting point would not necessarily navigate back to the previous image. In this case, a snap motion in one direction would be significant, but not the subsequent snap back.

In the present system, the first AP control (in response to the capture of touch event of the first type) and the third AP control (in response to the capture of a touch event of a different type) as seen in FIG. 4 are both associated to the portion of the AP GUI receiving the touch input. The second AP control (in response to the spatial movement) as well as the other AP control (in response to the termination of the clutch event) may either be associated to the portion of the GUI or not. For instance, the AP control could be the return to the initial AP GUI if the first AP control has modified the GUI. With the example of the buddy list application or photo gallery application, the association of the category to the clutched contact icon is indeed associated to the portion of the GUI as that portion, namely the clutched contact icon, remains on screen, and the categories are used to characterize the contact. In the illustration of FIGS. 5A and 5B, wherein the unclutched icons are moved away from the screen, the AP controls are actually associated to other portions of the GUI.

In the present system, the application program could either be a stand alone application resident on the mobile device (such as its operating system for instance) or the client to a web based application (such as map based application using for instance a client downloaded to the mobile device to upload a map).

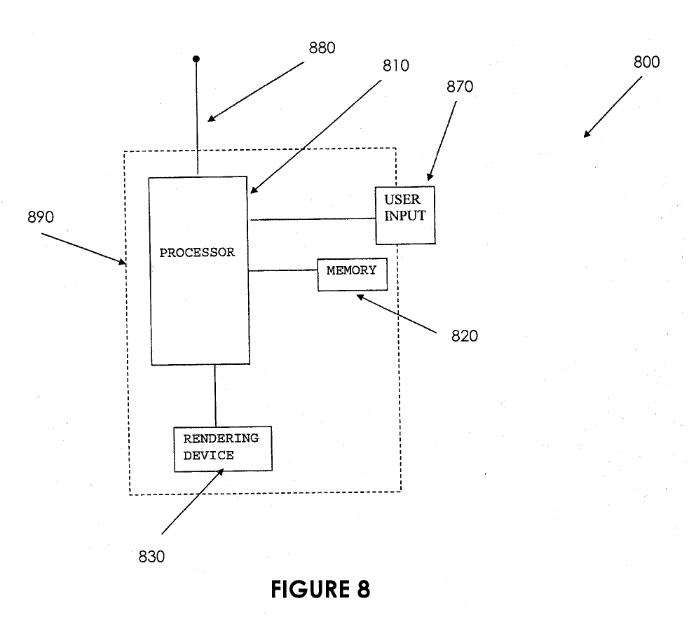

FIG. 8 shows a system 800 in accordance with an embodiment of the present system. The system 800 includes a user device 890 that has a processor 810 operationally coupled to a memory 820, a rendering device 830, such as one or more of a display, speaker, etc., a user input device 870, such as a sensor panel, and a connection 880 operationally coupled to the user device 890. The connection 880 may be an operable connection between the device 890, as a user device, and another device that has similar elements as the device 890, such as a web server such as one or more content providers. The user device may be for instance a mobile phone, a smart phone, a PDA (personal digital assistant) or any type of wireless portable device. The present method is suited for a wireless device with a display panel that is also a sensor panel to offer the user an enhanced control over an application program running on the user device.

The memory 820 may be any type of device for storing for instance the application data related to the micro server of one illustration, to the operating system, to the browser as well as to the different application programs controllable with the present method. The application data are received by the processor 810 for configuring the processor 810 to perform operation acts in accordance with the present system. The operation acts include rendering a GUI of the AP, capturing on the sensor panel a touch input on a portion of the AP GUI, and when the touch input is identified as a touch input of a first type, imparting a first AP control associated to the portion of the GUI; monitoring an occurrence of a spatial movement of the mobile device; and imparting a second AP control associated to the portion of the GUI in response to the capture of a spatial movement.

The user input 870 may include the sensor panel as well as a keyboard, mouse, trackball, touchpad or other devices, which may be stand alone or be a part of a system, such as part of a personal computer (e.g., desktop computer, laptop computer, etc.) personal digital assistant, mobile phone, converged device, or other rendering device for communicating with the processor 810 via any type of link, such as a wired or wireless link. The user input device 870 is operable for interacting with the processor 810 including interaction within a paradigm of a GUI and/or other elements of the present system, such as to enable web browsing, selection of the portion of the GUI provided by a touch input.

In accordance with an embodiment of the present system, the rendering device 830 may operate as a touch sensitive display for communicating with the processors 810 (e.g., providing selection of portions of the AP GUI). In this way, a user may interact with the processor 810 including interaction within a paradigm of a GUI, such as to operation of the present system, device and method. Clearly the user device 890, the processor 810, memory 820, rendering device 830 and/or user input device 870 may all or partly be portions of a computer system or other device, and/or be embedded in a portable device, such as a mobile telephone, personal computer (PC), personal digital assistant (PDA), converged device such as a smart telephone, etc.

The system, device and method described herein address problems in prior art systems. In accordance with an embodiment of the present system, the device 890, corresponding user interfaces and other portions of the system 800 are provided for imparting an enhanced control in accordance with the present system over application program.

The methods of the present system are particularly suited to be carried out by a computer software program, such program containing modules corresponding to one or more of the individual steps or acts described and/or envisioned by the present system, such as the different drivers, the micro server, the web rendering engine, etc. Such program may of course be embodied in a computer-readable medium, such as an integrated chip, a peripheral device or memory, such as the memory 820 or other memory coupled to the processor 810.

The computer-readable medium and/or memory 820 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling, etc. Any medium known or developed that can store and/or transmit information suitable for use with a computer system may be used as the computer-readable medium and/or memory 820.

Additional memories may also be used. These memories configure processor 810 to implement the methods, operational acts, and functions disclosed herein. The operation acts may include controlling the rendering device 830 to render elements in a form of a GUI and/or controlling the rendering device 830 to render other information in accordance with the present system.

Moreover, the term “memory” should be construed broadly enough to encompass any information able to be read from or written to an address in the addressable space accessed by a processor. With this definition, information on a network is still within memory 820, for instance, because the processor 810 may retrieve the information from the network for operation in accordance with the present system. For example, a portion of the memory as understood herein may reside as a portion of the content providers, and/or the user device.

The processor 810 is capable of providing control signals and/or performing operations in response to input signals from the user input device 870 and executing instructions stored in the memory 820. The processor 810 may be an application-specific or general-use integrated circuit(s). Further, the processor 810 may be a dedicated processor for performing in accordance with the present system or may be a general-purpose processor wherein only one of many functions operates for performing in accordance with the present system. The processor 810 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. Thus, while the present system has been described with reference to exemplary embodiments, including user interfaces, it should also be appreciated that numerous modifications and alternative embodiments may be devised by those having ordinary skill in the art without departing from the broader and intended spirit and scope of the present system as set forth in the claims that follow. Further, while exemplary user interfaces are provided to facilitate an understanding of the present system, other user interfaces may be provided and/or elements of one user interface may be combined with another of the user interfaces in accordance with further embodiments of the present system.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

1. A method for imparting control to an application program (AP) running on a mobile device, said method comprising the acts of:
displaying a graphical user interface (GUI) of the AP on a touch panel of the mobile device;
capturing a touch input on a portion of the GUI;
the method further comprising, when identifying the touch input as a touch input of a predefined first type, the acts of:
imparting a first AP control associated to the portion of the GUI;
monitoring an occurrence of a spatial movement of the mobile device;
imparting a second AP control in response to the capture of a spatial movement.

2. The method according to claim 1, further comprising the act of:
imparting a third AP control associated to the portion of the GUI when identifying that the touch input is not of the predefined first type.

3. The method according to claim 2, wherein the touch input is a touch input lasting less than a predefined duration.

4. The method according to claim 1, wherein the first type of touch input is a touch input lasting longer then a predefined duration.

5. The method according to claim 4, wherein the act of monitoring an occurrence is carried out if the touch input is terminated.

6. The method according to claim 5, wherein the act of monitoring the occurrence of a spatial movement is stopped when a further touch input is captured on the touch panel.

7. The method according to claim 4, wherein the act of imparting the second AP control is carried out once the touch input is terminated.

8. The method according to claim 4, wherein the act of imparting the second AP control is carried out if the touch input has not been terminated, the method further comprising an act of imparting a fourth AP control once the touch input is terminated.

9. The method according to claim 1, wherein the first AP control comprises the act of displaying a plurality of interface cues in different directions around the portion of the GUI, each interface cue being associated to a further AP control, the second AP control comprising the act of imparting the further AP control.

10. A mobile device for imparting control to an application program (AP) running on said mobile device, said mobile device being arranged to:
display a graphical user interface (GUI) of the AP on a touch panel of the mobile device;
capture a touch input on a portion of the GUI;
the mobile device being further arranged, when identifying the touch input as a touch input of a predefined first type, to:
impart a first AP control associated to the portion of the GUI;
monitor an occurrence of a spatial movement of the mobile device;
impart a second AP control in response to the capture of a spatial movement.

11. An application embodied in instructions on a computer readable medium and arranged to impart control to an application program (AP) running on a mobile device having a processor for executing the instructions, the application comprising instructions for: displaying a graphical user interface (GUI) of the AP on a touch panel of the mobile device;
capturing a touch input on a portion of the GUI;
the application being further arranged, when identifying that the touch input is a touch input of a predefined first type, in instructions for:
imparting a first AP control associated to the portion of the GUI;
monitoring an occurrence of a spatial movement of the mobile device; and
imparting a second AP control in response to the capture of a spatial movement.
